(19) United States
(12) Patent Application Publication
(10) Pub. No.: US 2026/0119749 A1
(43) Pub. Date: Apr. 30, 2026

(54) Generation Method for Optimal Transformation Strategy for Building Energy, Computer Device, and Storage Medium

(71) Applicants: China Construction Science and Industry Corporation LTD., Shenzhen (CN); Tongji University, Shanghai (CN)

(72) Inventors: Renge Li, Shenzhen (CN); Jiawei Yao, Shanghai (CN); Rong Qu, Shenzhen (CN); Chenyu Huang, Shanghai (CN); Ying Wei, Shenzhen (CN)

(21) Appl. No.: 18/979,588

(22) Filed: Dec. 12, 2024

(30) Foreign Application Priority Data
Oct. 31, 2024 (CN) 202411539474.3

(51) Int. Cl. G06F 30/27; G06F 119/06; G06F 119/08

(52) U.S. Cl. CPC G06F 30/27; G06F 2119/06; G06F 2119/08

(57) ABSTRACT

The present invention provides a generation method and apparatus for an optimal transformation strategy for building energy, a device, and a medium. An urban building energy simulation result is obtained on the basis of multidimensional data, and a training sample is constructed to perform integrated training on a plurality of machine learning models to obtain a surrogate model, in this way, during subsequent building performance simulation, the surrogate model can be directly used for prediction, so that the processing efficiency is increased; and multi-objective optimization processing is performed on the basis of the surrogate model and a parallel genetic algorithm plugin, so that an optimal transformation strategy for a target building is rapidly generated. Not only is the quantification for a transformation result achieved, but also the generated transformation strategy is more reasonable.

### CROSS REFERENCES TO RELATED APPLICATION

The present application claims the benefit of Chinese Patent Application No. 202411539474.3 filed on Oct. 31, 2024, the contents of which are incorporated herein by reference in their entirety.

### TECHNICAL FIELD

The present invention relates to the technical field of artificial intelligence, in particular to a generation method for an optimal transformation strategy for building energy, a computer device, and a storage medium.

### BACKGROUND ART

With the continuous advancement of urbanization, the urban heat island effect is becoming more and more serious, and the urban heat island effect has a significant impact on urban building energy consumption.

For the above-mentioned problem, the implementation of effective building energy transformation is crucial for increasing urban energy efficiency and reducing carbon emission.

However, an existing building energy transformation solution only depends on empiricism, a transformation effect cannot be quantified, and a specific transformation strategy cannot be given purposefully according to specific cases; and at the same time, the existing building energy transformation solution needs to take energy consumption simulation as an evaluation basis so as to still have the problem of long time consumption.

### SUMMARY OF THE INVENTION

In view of above contents, it is necessary to provide a generation method for an optimal transformation strategy for building energy, a computer device, and a storage medium to solve the problem that the optimal transformation strategy for the building energy cannot be generated efficiently and purposefully.

Provided is a generation method for an optimal transformation strategy for building energy, wherein the generation method and apparatus for the optimal transformation strategy for the building energy includes:
acquiring building data of a target city to construct an urban model;
acquiring urban typical meteorological year data and greening data of the target city, and inputting the urban model, the urban typical meteorological year data and the greening data to an Urban Weather Generator to obtain weather data affected by an urban heat island effect of the target city;
calling a building energy consumption simulation engine to simulate building energy consumption of the target city on the basis of the urban model, the urban typical meteorological year data or the weather data affected by the urban heat island effect to obtain an urban building energy simulation result of the target city;
constructing a training sample according to the urban building energy simulation result to perform integrated training on a plurality of machine learning models to obtain a surrogate model;
in response to a transformation strategy generation instruction for a target building in the target city, acquiring building data of the target building on the basis of a data dimension of the training sample, and calling a parallel genetic algorithm plugin to generate a plurality of initial transformation strategies of the target building; and
inputting the building data and the plurality of initial transformation strategies to the surrogate model, and performing multi-objective optimization processing on the plurality of initial transformation strategies on the basis of the parallel genetic algorithm plugin and an output of the surrogate model to obtain an optimal transformation strategy of the target building.

Provided is a computer device, wherein the computer device includes:
a memory configured to store at least one instruction; and
a processor configured to execute the instruction stored in the memory so as to implement the generation method for the optimal transformation strategy for the building energy.

Provided is a computer-readable storage medium, wherein the computer-readable storage medium has at least one instruction stored therein, and the at least one instruction is executed by the processor in the computer device so as to implement the generation method for the optimal transformation strategy for the building energy.

It can be seen from above technical solutions that on one hand, the urban building energy simulation result is obtained on the basis of multidimensional data, and the training sample is constructed according to the urban building energy simulation result to perform integrated training on the plurality of machine learning models to obtain the surrogate model, in this way, during subsequent building performance simulation, the surrogate model can be directly used for prediction without performing long-term energy consumption simulation every time, so that the processing efficiency is increased; and on the other hand, multi-objective optimization processing is performed on the basis of the surrogate model and the parallel genetic algorithm plugin, so that an optimal transformation strategy for a target building is rapidly generated. Not only is the quantification for a transformation result achieved, but also there is no dependence on empiricism, so that the generated transformation strategy is more reasonable.

### BRIEF DESCRIPTION OF THE DRAWINGS

FIG. 1 is a process diagram of an embodiment of a generation method for an optimal transformation strategy for building energy in the present invention;

FIG. 2 is a functional module diagram of an embodiment of a generation apparatus for an optimal transformation strategy for building energy in the present invention; and

FIG. 3 is a schematic structural diagram of a computer device for implementing the embodiment of the generation method for the optimal transformation strategy for the building energy in the present invention.

### DETAILED DESCRIPTION OF THE INVENTION

In order to make the objects, technical solutions and advantages of the present invention clearer, the present invention will be described below in detail in conjunction with the accompanying drawings and specific embodiments.

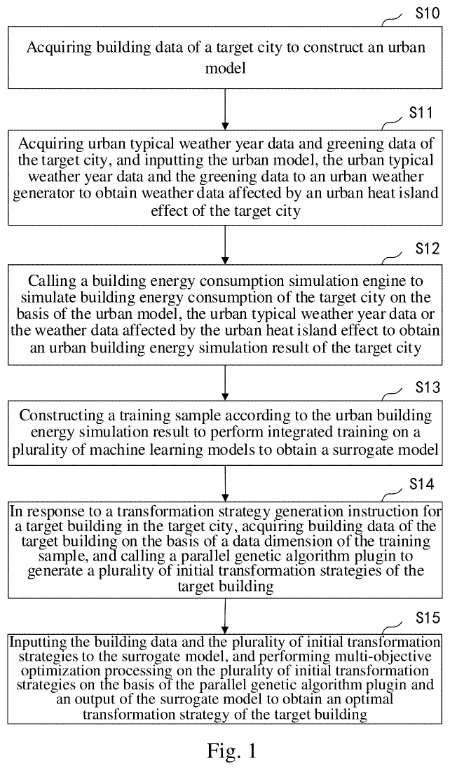

As shown in FIG. 1, a process diagram of an embodiment of a generation method for an optimal transformation strategy for building energy in the present invention is shown. According to different demands, an order of steps in the flow diagram can be changed, and some steps can be omitted.

The generation method for the optimal transformation strategy for the building energy is applied to one or more computer devices, the computer device is a device capable of automatically performing numerical computation and/or information processing according to instructions set or stored in advance, and hardware thereof includes, but is not limited to a microprocessor, an Application Specific Integrated Circuit (ASIC), a Field-Programmable Gate Array (FPGA), a Digital Signal Processor (DSP), and an embedded device.

The computer device can be a computer or a cloud platform, and can be a device capable of calling rhino and grasshopper.

Artificial Intelligence (AI) is a theory, a method, a technology and an application system that utilizes digital computers or machines controlled by the digital computers to simulate, extend and expand human intelligence, perceive environments, acquire knowledge and use knowledge to obtain the best results.

Basic technologies of artificial intelligence generally include technologies, such as a sensor technology, a dedicated artificial intelligence chip technology, a cloud computation technology, a distributed storage technology, a big data processing technology, an operation/interaction system technology, and an electromechanical integration technology. Artificial intelligence software technologies mainly include a computer vision technology, a robot technology, a biological recognition technology, a voice processing technology, a natural language processing technology, a machine learning/deep learning technology, etc.

Networks that the computer device is located include, but are not limited to the Internet, a wide area network, a metropolitan area network, a local area network, and a Virtual Private Network (VPN).

S10, building data of a target city is acquired to construct an urban model.

In the present embodiment, the step that building data of a target city is acquired to construct an urban model includes:
building features, building surrounding features and building thermal features of specified types of buildings in the target city are acquired to construct the urban model;
wherein the building features are configured to characterize geometric properties of buildings;
wherein the building surrounding features are configured to characterize geometric properties of surrounding buildings;
wherein the building thermal features are configured to characterize thermal properties of maintenance structural materials (including a wall material, glass, etc.) of buildings; and
wherein the specified types of buildings include office buildings and commercial buildings.

For example, the building features can include, but are not limited to one or combinations of a plurality of features described as follows: total building area, a building volume, a building height, window area, and a shape coefficient.

The total building area refers to total area of all floors of a building;
the building volume refers to a total volume of a space occupied by the building and includes a total volume of all the floors;
the building height refers to a distance from the highest point of the building to the ground or foundation;
the window area refers to total area of all windows of the building; and
the shape coefficient refers to a ratio of a surface area and a volume of the building in contact with the air.

For example, the building surrounding features can include, but are not limited to one or combinations of a plurality of features described as follows: the number of surrounding buildings, a building density, a distance among the buildings, a sky view factor, and a perimeter-to-area ratio.

The number of surrounding buildings refers to a sum of buildings in a buffering area;
the building density refers to a ratio of bottom area of the buildings in the buffering area to area of the buffering area;
the distance among the buildings refers to an average value of distances among the buildings in the buffering area;
the sky view factor refers to a ratio of sky area observed on the ground to total view area; and
the perimeter-to-area ratio refers to a ratio of a perimeter of an outer contour of a building to area occupied by the building.

For example, the building thermal features can include, but are not limited to one or combinations of a plurality of features described as follows: a thermal resistance value of an exterior wall body, a thermal resistance value of an interior wall body, etc.

The building features and the building surrounding features can be computed by a Geographic Information System (GIS) platform.

In the above-mentioned embodiment, the urban model is constructed on the basis of multidimensional variables of the building features, the building surrounding features, and the building thermal features, so that the established model can express properties of urban buildings more accurately.

S11, urban typical meteorological year data and greening data of the target city are acquired, and the urban model, the urban typical meteorological year data and the greening data are inputted to an Urban Weather Generator (UWG) to obtain weather data affected by an urban heat island effect of the target city.

In the present embodiment, the urban typical meteorological year data can be derived from a high-reliability weather database, such as an EnergyPlus typical meteorological year database.

In the present embodiment, the greening data can include a greening index, such as a tree coverage rate and a grass coverage rate.

In the present embodiment, the urban model, the urban typical meteorological year data and the greening data are inputted to the Urban Weather Generator, by which the weather data affected by the urban heat island effect of the target city can be rapidly generated.

S12, a building energy consumption simulation engine is called to simulate building energy consumption of the target city on the basis of the urban model, the urban typical meteorological year data or the weather data affected by the urban heat island effect to obtain an urban building energy simulation result of the target city.

For example, the building energy consumption simulation engine can be an EnergyPlus engine. By executing Urban Building Energy Modeling (UBEM), energy consumption under the following four scenarios can be simulated: energy consumption of the office buildings under the urban typical meteorological year data, energy consumption of the commercial buildings under the urban typical meteorological year data, energy consumption of the office buildings under the weather data affected by the urban heat island effect, and energy consumption of the commercial buildings under the weather data affected by the urban heat island effect.

After the urban building energy simulation result of the target city is obtained, in order to further ensure the accuracy of the model, a building energy consumption report of the target city can also be acquired, and the urban building energy simulation result of the target city is compared with the building energy consumption report to determine the accuracy of the urban building energy simulation result, thereby further ensuring the availability of the urban building energy simulation result.

S13, a training sample is constructed according to the urban building energy simulation result to perform integrated training on a plurality of machine learning models to obtain a surrogate model.

In the present embodiment, the step of a training sample is constructed according to the urban building energy simulation result to perform integrated training on a plurality of machine learning models to obtain a surrogate model includes:
a building feature, a building surrounding feature and a building thermal feature of each building are generated according to the urban building energy simulation result;
a transformation strategy and a total building load of each building are acquired;
a preset number of machine learning models are called; and
with the building feature, the building surrounding feature and the building thermal feature of each building as inputs and the total building load of each building as a training object, integrated training is performed on the machine learning models to obtain the surrogate model;
wherein during training, model parameters are optimized by using a Bayesian optimization algorithm.

The preset number can be configured according to an actual demand on accuracy.

For example, when the preset number is six, the machine learning models can include six integrated learning algorithm models: a Bagging Classifier (BR) model, an Extremely randomized trees (ETR) model, a Random Forest Regression (RFR) model, a Gradient Boosting Regression (GBR) model, an Adaptive Boosting (ADB) model, and an Extreme Gradient Boosting (XGB) model. By performing integrated training on the above-mentioned six models, outputs of the six models can be integrated to obtain a more accurate prediction result.

In the present embodiment, an energy model driven by data is constructed by using the machine learning models, the energy consumption in various scenarios (such as the energy consumption of the office buildings under the urban typical meteorological year data, the energy consumption of the commercial buildings under the urban typical meteorological year data, the energy consumption of the office buildings under the weather data affected by the urban heat island effect, and the energy consumption of the commercial buildings under the weather data affected by the urban heat island effect) obtained by batch simulation according to the urban building energy simulation result are used as objects to respectively train the machine learning models, and the outputs of all the models are integrated on the basis of an integrated algorithm, so that the prediction result of the surrogate model is more accurate.

Further, in order to verify the accuracy of the surrogate model, basic model Support Vector Regression (SVR) can also be used as a contrast, so that advantages of the surrogate model obtained by integrated learning are verified.

In the present embodiment, after the surrogate model is obtained, the method further includes: sensitivity detection, interpretability detection and uncertainty detection is performed on the surrogate model; and
when the surrogate model does not pass the sensitivity detection, and/or the interpretability detection, and/or the uncertainty detection, optimization training is performed on the surrogate model;
wherein when the surrogate model does not pass the sensitivity detection, it is determined that the data volume of the training sample is insufficient, and the training sample is supplemented on the basis of the urban building energy simulation result, and optimization training is performed on the surrogate model on the basis of the supplemented training sample.

The sensitivity detection means that it is detected whether the data volume is sufficient. For example, for each group of training, the data volume is accumulatively increased by 2% every time to train a plurality of models, and performances of the models tend to be stable, which indicates that the training data is sufficient.

The interpretability detection means that contributions of all the features are detected. For example, a SHapley Additive explanations (SHAP) based on a game theory can be used to explain that an optimal model is configured to determine the contributions of all the features to performances of the building energy.

The uncertainty detection means that an average output and confidence levels of the models are detected. For example, the average output and confidence levels of the models can be determined on the basis of a series of model prediction results by performing 95% bootstrap on a training dataset and training a certain number of models.

By means of the above-mentioned embodiments, the accuracy of the models can be further verified.

S14, in response to a transformation strategy generation instruction for a target building in the target city, building data of the target building is acquired on the basis of a data dimension of the training sample, and a parallel genetic algorithm plugin is called to generate a plurality of initial transformation strategies of the target building.

In the present embodiment, the transformation strategy generation instruction can be triggered by related working staff such as an architectural designer.

For example, a building feature, a building surrounding feature and a building thermal feature of the target building can be acquired according to the data dimension of the training sample.

In the present embodiment, the step that a parallel genetic algorithm plugin is called to generate a plurality of initial transformation strategies of the target building includes:
a plurality of transformation parameters under the transformation strategy and a sampling range of a value of each of the transformation parameters are acquired;
the value of each of the transformation parameters is sampled within a corresponding sampling range on the basis of the parallel genetic algorithm plugin to obtain a plurality of transformation parameter sets; and
each set of transformation parameters is taken as one of the initial transformation strategies to obtain the plurality of initial transformation strategies.

For example, the plurality of transformation parameters under the transformation strategy and the sampling range of the value of each of the transformation parameters can refer to the following table:

| Transformation parameter | Sampling range |
|---|---|
| North window-to-wall ratio | [0.2-0.8] |
| East window-to-wall ratio | [0.2-0.8] |
| South window-to-wall ratio | [0.2-0.8] |
| West window-to-wall ratio | [0.2-0.8] |
| Thermal resistance of exterior | [0.667-2.80] |
| wall | |
| Thermal resistance of roof | [0.604-2.350] |
| Thermal resistance of floor slab | [0.667-1.42] |
| U value of glass | [1.0-5.2] |
| Heat gain coefficient of glass | [0.18-0.52] |

Further, a north window-to-wall ratio 0.2, an east window-to-wall ratio 0.2, a south window-to-wall ratio 0.2, a west window-to-wall ratio 0.2, the thermal resistance 0.667 of an exterior wall, the thermal resistance 0.604 of a roof, the thermal resistance 0.667 of a floor slab, a U value 1 of glass and a heat gain coefficient 0.18 of the glass can be sampled within a sampling range of each transformation parameter on the basis of the parallel genetic algorithm plugin to form an initial transformation strategy; and a north window-to-wall ratio 0.8, an east window-to-wall ratio 0.8, a south window-to-wall ratio 0.8, a west window-to-wall ratio 0.8, the thermal resistance 2.80 of an exterior wall, the thermal resistance 2.350 of a roof, the thermal resistance 1.42 of a floor slab, a U value 5.2 of glass and a heat gain coefficient 0.52 of the glass are sampled to form an initial transformation strategy and so on, and finally, the plurality of initial transformation strategies are formed.

The parallel genetic algorithm plugin can be an iGeneS parallel genetic algorithm plugin developed by the SD-II Lab of Tongji University, and is configured to execute a multi-objective optimization task. The iGeneS is a new-generation genetic algorithm plugin developed special for deploying a machine learning surrogate model, achieves batch calling of the surrogate model by means of a matrix operation, and greatly shortens the optimization time as comparison with a traditional optimization algorithm plugin.

Therefore, in the present embodiment, the value of each transformation parameter can be automatically sampled by using a parallel genetic algorithm to form the plurality of initial transformation strategies without the help of artificial experience, and therefore, the efficiency is higher.

S15, the building data and the plurality of initial transformation strategies are inputted to the surrogate model, and multi-objective optimization processing is performed on the plurality of initial transformation strategies on the basis of the parallel genetic algorithm plugin and an output of the surrogate model to obtain an optimal transformation strategy of the target building.

In the present embodiment, the step that the building data and the plurality of initial transformation strategies are inputted to the surrogate model, and multi-objective optimization processing is performed on the plurality of initial transformation strategies on the basis of the parallel genetic algorithm plugin and an output of the surrogate model to obtain an optimal transformation strategy of the target building includes:
constraint conditions are constructed on the basis of an ideal transformation cost;
a predicted total building load of each of the initial transformation strategies is determined according to the output of the surrogate model; and
the initial transformation strategy with the lowest predicted total building load is acquired as the optimal transformation strategy by using the parallel genetic algorithm plugin under the constraint conditions.

Specifically, the step that constraint conditions are constructed on the basis of an ideal transformation cost includes:

the constraint conditions are constructed by adopting the following formula:

$$Cost = {\sum }_{i = 1}^{n} {ω}_{i} {ε}_{i} ;$$

wherein Cost represents the ideal transformation cost, ωᵢ represents a cost weight of an i^{th} transformation parameter under the adopted transformation strategy, εᵢ represents a linear cost index corresponding to a value of the i^{th} transformation parameter if a transformation cost of each transformation parameter within the corresponding sampling range linearly changes under the adopted transformation strategy, and n is a positive integer;

$$wherein {ε}_{i} = \{ \begin{matrix}\frac{{x}_{i} - {a}_{i}}{{b}_{i} - {a}_{i}} , & {ρ}_{{Value}_{i} - Cost} > & 0 \\ \frac{{x}_{i} - {a}_{i}}{{b}_{i} - {a}_{i}} , & {ρ}_{{Value}_{i} - Cost} < & 0\end{matrix} ;$$

wherein xᵢ represents the value of the i^{th} transformation parameter; aᵢ represents an upper limit of a sampling range of the i^{th} transformation parameter; bᵢ represents a lower limit of the sampling range of the i^{th} transformation parameter; and ρ_{Value}_{ᵢ}_{-Cost} represents a correlation between the value of the i^{th} transformation parameter and the transformation cost, wherein when ρ_{Value}_{ᵢ}_{-Cost}>0, it indicates that the i^{th} transformation parameter is positively correlated with the transformation cost, and the greater the value of the i^{th} transformation parameter is, the higher the corresponding transformation cost is, and when ρ_{Value}_{ᵢ}_{-Cost}<0, it indicates that the 7th transformation parameter is negatively correlated with the transformation cost, and the smaller the value of the i^{th} transformation parameter is, the higher the corresponding transformation cost is. When ρ_{Value}_{ᵢ}_{-Cost}=0, it indicates that the i^{th} transformation parameter is unrelated to the transformation cost.

In the above-mentioned embodiment, multi-objective optimization is performed on the surrogate model with the total building load and the transformation cost as objects, so that the situation that the cost exceeds the standard because the transformation parameters are all converged to optimal thermal values can be avoided while the lowest total building load is ensured, and then, the generated optimal transformation strategy reaches an ideal balanced state between the total building load and the transformation cost.

By means of the present embodiment, an optimal transformation strategy for building energy in a typical city can be obtained, and building energy transformation solutions for similar cities are searched according to the optimal transformation strategy for the building energy in the typical city. For example, by searching an optimal transformation strategy for building energy in Shenzhen, it is expected to provide reference for other big cities also subjected to the heat island effect.

It can be seen from above technical solutions that on one hand, the urban building energy simulation result is obtained on the basis of multidimensional data, and the training sample is constructed according to the urban building energy simulation result to perform integrated training on the plurality of machine learning models to obtain the surrogate model, in this way, during subsequent building performance simulation, the surrogate model can be directly used for prediction without performing long-term energy consumption simulation every time, so that the processing efficiency is increased; and on the other hand, multi-objective optimization processing is performed on the basis of the surrogate model and the parallel genetic algorithm plugin, so that an optimal transformation strategy for a target building is rapidly generated. Not only is the quantification for a transformation result achieved, but also there is no dependence on empiricism, so that the generated transformation strategy is more reasonable.

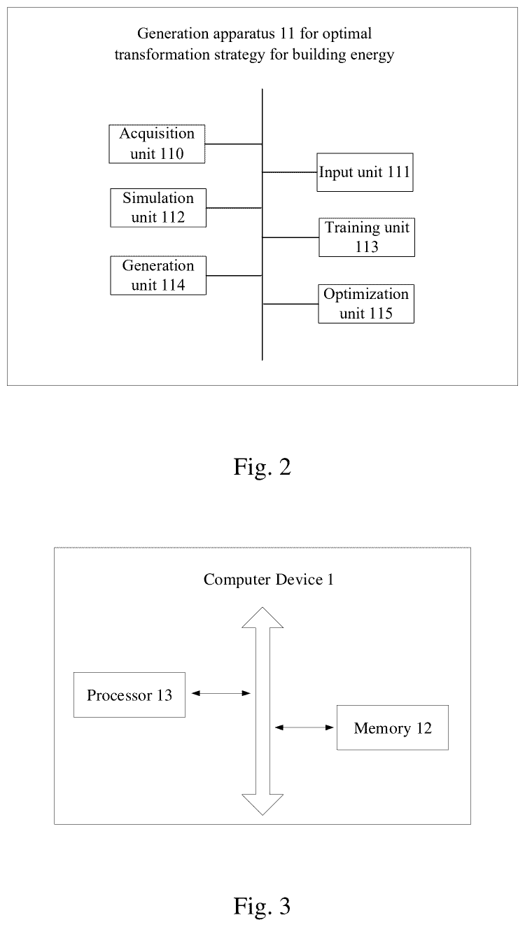

As shown in FIG. 2, a functional module diagram of an embodiment of a generation apparatus for an optimal transformation strategy for building energy in the present invention is shown. The generation apparatus 11 for the optimal transformation strategy for the building energy includes an acquisition unit 110, an input unit 111, a simulation unit 112, a training unit 113, a generation unit 114, and an optimization unit 115. The modules/units in the present invention refer to a series of computer program segments that can be executed by a processor and can complete fixed functions, and the computer program segments are stored in a memory. In the present embodiment, functions of all the modules/units will be described in detail in the subsequent embodiments.

The acquisition unit 110 is configured to acquire building data of a target city to construct an urban model;
the input unit is configured to acquire urban typical meteorological year data and greening data of the target city, and input the urban model, the urban typical meteorological year data and the greening data to an Urban Weather Generator to obtain weather data affected by an urban heat island effect of the target city;
the simulation unit 112 is configured to call a building energy consumption simulation engine to simulate building energy consumption of the target city on the basis of the urban model, the urban typical meteorological year data or the weather data affected by the urban heat island effect to obtain an urban building energy simulation result of the target city;
the training unit 13 is configured to construct a training sample according to the urban building energy simulation result to perform integrated training on a plurality of machine learning models to obtain a surrogate model;
the generation unit 114 is configured to, in response to a transformation strategy generation instruction for a target building in the target city, acquire building data of the target building on the basis of a data dimension of the training sample, and call a parallel genetic algorithm plugin to generate a plurality of initial transformation strategies of the target building; and
the optimization unit 115 is configured to input the building data and the plurality of initial transformation strategies to the surrogate model, and perform multi-objective optimization processing on the plurality of initial transformation strategies on the basis of the parallel genetic algorithm plugin and an output of the surrogate model to obtain an optimal transformation strategy of the target building.

It can be seen from above technical solutions that on one hand, the urban building energy simulation result is obtained on the basis of multidimensional data, and the training sample is constructed according to the urban building energy simulation result to perform integrated training on the plurality of machine learning models to obtain the surrogate model, in this way, during subsequent building performance simulation, the surrogate model can be directly used for prediction without performing long-term energy consumption simulation every time, so that the processing efficiency is increased; and on the other hand, multi-objective optimization processing is performed on the basis of the surrogate model and the parallel genetic algorithm plugin, so that an optimal transformation strategy for a target building is rapidly generated. Not only is the quantification for a transformation result achieved, but also there is no dependence on empiricism, so that the generated transformation strategy is more reasonable.

As shown in FIG. 3, a schematic structural diagram of a computer device for implementing the embodiment of the generation method for the optimal transformation strategy for the building energy in the present invention is shown.

The computer device 1 can include a memory 12, a processor 13 and a bus, and can further include a computer program, such as a generation program for an optimal transformation strategy for building energy, stored in the memory 12 and capable of running on the processor 13.

It can be understood by the skilled in the art that the schematic diagram only shows an example of the computer device 1, but does not constitute a limitation on the computer device 1. The computer device 1 not only can be of a bus structure, but also can be a star-shaped structure, and the computer device 1 can further include other more or less hardware or software than that shown in the figure, or include different component layouts. For example, the computer device 1 can further include an input and output device, a network access device, etc.

It should be noted that the computer device 1 is only an example, if other electronic products that have existed or may appear in the future are applicable to the present invention, they should also fall within the protective scope of the present invention, and are included herein by reference.

The memory 12 at least includes one type of readable storage medium which includes a flash memory, a mobile hard disk, a multimedia card, a card-type memory (such as an SD or a DX memory), a magnetic memory, a magnetic disk, an optical disk, etc. In some embodiments, the memory 12 can be an internal storage unit of the computer device 1, such as a mobile hard disk of the computer device 1. In some other embodiments, the memory 12 can also be an external storage device of the computer device 1, such as a plug-in mobile hard disk, a Smart Media Card (SMC), a Secure Digital (SD) and a Flash Card that are equipped on the computer device 1. Further, the memory 12 can further include both the internal storage unit and the external storage device of the computer device 1. The memory 12 not only can be configured to store application software installed on the computer device 1 and various data, such as a code of the generation program for the optical transformation strategy for the building energy, but also can be configured to temporarily store data that has been outputted or is to be outputted.

In some embodiments, the processor 13 can consist of an integrated circuit, such as a single packaged integrated circuit, or can consist of a plurality of packaged integrated circuits with the same or different functions, and includes one or more Central Processing units (CPU), a microprocessor, a digital processing chip, a graphics processor, a combination of various control chips, etc. The processor 13 is a control core (Control Unit) of the computer device 1, is connected with various components of the computer device 1 by means of various interfaces and lines, operates or executes a program or module (such as the generation program for the optimal transformation strategy for the building energy) stored in the memory 12 and calls the data stored in the memory 12 so as to execute various functions of the computer device 1 and process data.

The processor 13 executes an operating system of the computer device 1 and various installed applications. The processor 13 executes the applications so as to implement the steps in each of the above-mentioned embodiments of the generation method for the optimal transformation strategy for the building energy, such as steps shown in FIG. 1.

Exemplarily, the computer program can be segmented into one or more modules/units, the one or more modules/units are stored in the memory 12 and are executed by the processor 13 so as to complete the present invention. The one or more modules/units can be a series of computer-readable instruction segments capable of completing specific functions, and the instruction segments are configured to describe an execution process of the computer program in the computer device 1. For example, the computer program can be segmented into an acquisition unit 110, an input unit 111, a simulation unit 112, a training unit 113, a generation unit 114, and an optimization unit 115.

The above-mentioned integrated units implemented in a form of a software functional module can be stored in one computer-readable storage medium. The above-mentioned software functional module is stored in a storage medium and includes a plurality of instructions configured to enable a computer device (that can be a personal computer, a computer device, or a network device, etc.) or a processor to perform parts of the generation method for the optimal transformation strategy for the building energy in each of the embodiments of the present invention.

When being implemented in a form of a software functional unit and sold or used as independent products, the modules/units integrated on the computer device 1 can be stored in a computer-readable storage medium. Based on such understanding, all or parts of processes of the method in the above-mentioned embodiments of the present invention can also be completed by means of a computer program instructing related hardware devices, the computer program can be stored in a computer-readable storage medium, and when the computer program is executed by the processor, the steps in each of the above-mentioned method embodiments can be implemented.

The computer program includes computer program codes which can be in a source code form, an object code form, an executable file or some intermediate form, etc. The computer-readable medium can include any entities or apparatuses, recording media, U disks, mobile hard disks, magnetic disks, optical disks, computer memories, Read-Only Memories (ROM), random access memories, etc. capable of carrying the computer program codes.

Further, the computer-readable storage medium can mainly include a program storage area and a data storage area, wherein the program storage area can store an operating system, applications required by at least one function, etc.; and the data storage area can store data, etc. created according to the use of nodes of a blockchain.

The blockchain involved in the present invention is a novel application mode of computer technologies, such as distributed data storage, point-to-point transmission, a consensus mechanism, and an encryption algorithm. The Blockchain is essentially a decentralized database and is a series of data blocks associated by using a cryptographic method, each data block contains a batch of information of network transaction, which is configured to verify the validity (anti-counterfeiting) of the information thereof and generate the next block. The blockchain can include a blockchain underlying platform, a platform product service layer, an application service layer, etc.

The bus can be a peripheral component interconnect (PCI) bus or an extended industry standard architecture (EISA) bus, etc. The bus can be divided into an address bus, a data bus, a control bus, etc. For facilitating representation, the bus is only represented by using a straight line in FIG. 3, but it does not mean that there is only one bus or one type of bus. The bus is configured to implement connection and communication between the memory 12 and the at least one processor 13, etc.

Although it is not shown, the computer device 1 can further include a power source (such as a battery) supply power for each component. Preferably, the power source can be logically connected to the at least one processor 13 by a power management apparatus, and thus, functions, such as charge management, discharge management and power consumption management, are achieved by the power management apparatus. The power source can further include one or more direct-current or alternating-current power sources, a recharging apparatus, a power fault detection circuit, a power converter or inverter, a power state indicator or any components. The computer device 1 can further include various sensors, a Bluetooth module, a Wi-Fi module, etc., which are no longer repeated herein.

Further, the computer device 1 can further include a network interface. Optionally, the network interface can include a wired interface and/or a wireless interface (such as a WI-FI interface and a Bluetooth interface), and is usually configured to establish communication connection between the computer device 1 and other computer devices.

Optionally, the computer device 1 can further include a user interface which can be a Display and an input unit (such as a Keyboard). Optionally, the user interface can also be a standard wired interface and a wireless interface. Optionally, in some embodiments, the display can be an LED display, a liquid crystal display, a touch liquid crystal display, an Organic Light-Emitting Diode (OLED) touch display, etc. The display can also be appropriately known as a display screen or a display unit, and is configured to display information processed in the computer device 1 and display a visual user interface.

It should be known that the embodiment is only for a purpose of description, and a patent application range is not limited by such a structure.

FIG. 3 only shows the computer device 1 with components 12-13. It can be understood by the skilled in the art that a structure shown in FIG. 3 does not constitute a limitation on the computer device 1, and can include fewer or more components than the figure or combine with some components or have different component layouts.

In conjunction with FIG. 1, the memory 12 in the computer device 1 stores a plurality of instructions so as to implement the generation method for the optimal transformation strategy for the building energy, and the processor 13 can execute the plurality of instructions, thereby achieving the steps:
building data of a target city is acquired to construct an urban model;
urban typical meteorological year data and greening data of the target city are acquired, and the urban model, the urban typical meteorological year data and the greening data are inputted to an Urban Weather Generator to obtain weather data affected by an urban heat island effect of the target city;
a building energy consumption simulation engine is called to simulate building energy consumption of the target city on the basis of the urban model, the urban typical meteorological year data or the weather data affected by the urban heat island effect to obtain an urban building energy simulation result of the target city;
a training sample is constructed according to the urban building energy simulation result to perform integrated training on a plurality of machine learning models to obtain a surrogate model;
in response to a transformation strategy generation instruction for a target building in the target city, building data of the target building is acquired on the basis of a data dimension of the training sample, and a parallel genetic algorithm plugin is called to generate a plurality of initial transformation strategies of the target building; and
the building data and the plurality of initial transformation strategies are inputted to the surrogate model, and multi-objective optimization processing is performed on the plurality of initial transformation strategies on the basis of the parallel genetic algorithm plugin and an output of the surrogate model to obtain an optimal transformation strategy of the target building.

Specifically, a specific method that the processor 13 executes the above-mentioned instructions can refer to the description for related steps in the corresponding embodiment in FIG. 1 so as to be no longer repeated herein.

It should be noted that the data involved in the present solution is all acquired legally.

In the embodiments provided by the present invention, it should be understood that the disclosed system, apparatus and method can be implemented in other ways. For example, the apparatus embodiment described as above is only schematic. For example, module division is only logical function division, and there may be other division ways during actual implementation.

The present invention can be used in various universal or dedicated computer system environments or configurations, such as personal computers, server computers, multiprocessor systems, microprocessor-based systems, set-top boxes, programmable consumer electronic devices, network PCs, small-size computers, large-size computers, distributed computation environments including any one of above systems or devices, etc. The present invention can be described in a general context of a computer-executable instruction executed by a computer, such as a program module. Generally, the program module includes routines, programs, objects, components, data structures, etc. that perform specific tasks or implement specific abstract data types. The present invention can also be put into practice in the distributed computation environments in which tasks are executed by a remote processing device connected by a communication network. In the distributed computation environments, the program module can be located in local and remote computer storage media including storage devices.

Modules described as separation components can be or not be physically separated, and components displayed as modules can be or not be physical units, that is, they can be located on the same place or distributed on a plurality of network units. Parts or all of the modules can be selected according to an actual demand to achieve the purpose of the solution in the present embodiment.

In addition, all the functional modules in each embodiment of the present invention can be integrated in one processing unit, or each unit physically exists alone, or two or more units are integrated in one unit. The above-mentioned integrated units not only can be implemented in a form of hardware, but also can be implemented in a form of hardware and software functional modules.

For the skilled in the art, the present invention is not limited to details in the above-mentioned exemplary embodiments, and the present invention can be implemented in other specific forms without departing from the spirit or basic characteristics of the present invention.

Therefore, no matter it is seen from which point of view, the embodiment should be regarded as being exemplary and nonrestrictive. The scope of the present invention is limited by the appended claims instead of the above-mentioned description, and therefore, all variations falling within the meanings and scope of equivalent elements in the claims are intended to fall within the present invention. Any appended association diagram marks in the claims should not be regarded as limitations on the involved claims.

In addition, apparently, the word “include” does not exclude other units or steps, and a singular number does not exclude a plural number. A plurality of units or apparatuses described in the present invention can also be implemented by one unit or apparatus by means of software or hardware. Words such as first and second are configured to represent names, rather than to represent any specific orders.

Finally, it should be noted that above embodiments are only intended to describe the technical solutions of the present invention, rather than to limit them. Although the present invention has been described in detail with reference to the embodiments, it should be understood by those of ordinary skill in the art that the technical solutions of the present invention can be modified or equivalently replaced without departing from spirits and scopes of the technical solutions of the present invention.

1. A generation method for an optimal transformation strategy for building energy, wherein the generation method for the optimal transformation strategy for the building energy comprises:
acquiring building data of a target city to construct an urban model;
acquiring urban typical meteorological year data and greening data of the target city, and inputting the urban model, the urban typical meteorological year data and the greening data to an Urban Weather Generator to obtain weather data affected by an urban heat island effect of the target city;
calling a building energy consumption simulation engine to simulate building energy consumption of the target city on the basis of the urban model, the urban typical meteorological year data or the weather data affected by the urban heat island effect to obtain an urban building energy simulation result of the target city;
constructing a training sample according to the urban building energy simulation result to perform integrated training on a plurality of machine learning models to obtain a surrogate model;
in response to a transformation strategy generation instruction for a target building in the target city, acquiring building data of the target building on the basis of a data dimension of the training sample, and calling a parallel genetic algorithm plugin to generate a plurality of initial transformation strategies of the target building; and
inputting the building data and the plurality of initial transformation strategies to the surrogate model, and performing multi-objective optimization processing on the plurality of initial transformation strategies on the basis of the parallel genetic algorithm plugin and an output of the surrogate model to obtain an optimal transformation strategy of the target building.

2. The generation method for the optimal transformation strategy for the building energy of claim 1, wherein the acquiring building data of a target city to construct an urban model comprises:
acquiring building features, building surrounding features and building thermal features of specified types of buildings in the target city to construct the urban model;
wherein the building features are configured to characterize geometric properties of buildings;
wherein the building surrounding features are configured to characterize geometric properties of surrounding buildings;
wherein the building thermal features are configured to characterize thermal properties of maintenance structural materials of buildings; and
wherein the specified types of buildings comprise office buildings and commercial buildings.

3. The generation method for the optimal transformation strategy for the building energy of claim 2, wherein the constructing a training sample according to the urban building energy simulation result to perform integrated training on a plurality of machine learning models to obtain a surrogate model comprises:
generating a building feature, a building surrounding feature and a building thermal feature of each building according to the urban building energy simulation result;
acquiring a transformation strategy and a total building load of each building;
calling a preset number of machine learning models; and
with the building feature, the building surrounding feature and the building thermal feature of each building as inputs and the total building load of each building as a training object, performing integrated training on the machine learning models to obtain the surrogate model;
wherein during training, model parameters are optimized by using a Bayesian optimization algorithm.

4. The generation method for the optimal transformation strategy for the building energy of claim 3, wherein after the surrogate model is obtained, the method further comprises:
performing sensitivity detection, interpretability detection and uncertainty detection on the surrogate model; and
when the surrogate model does not pass the sensitivity detection, and/or the interpretability detection, and/or the uncertainty detection, performing optimization training on the surrogate model;
wherein when the surrogate model does not pass the sensitivity detection, it is determined that the data volume of the training sample is insufficient, and the training sample is supplemented on the basis of the urban building energy simulation result, and optimization training is performed on the surrogate model on the basis of the supplemented training sample.

5. The generation method for the optimal transformation strategy for the building energy of claim 3, wherein the calling a parallel genetic algorithm plugin to generate a plurality of initial transformation strategies of the target building comprises:
acquiring a plurality of transformation parameters under the transformation strategy and a sampling range of a value of each of the transformation parameters;
sampling the value of each of the transformation parameters within a corresponding sampling range on the basis of the parallel genetic algorithm plugin to obtain a plurality of transformation parameter sets; and
taking each set of transformation parameters as one of the initial transformation strategies to obtain the plurality of initial transformation strategies.

6. The generation method for the optimal transformation strategy for the building energy of claim 5, wherein the inputting the building data and the plurality of initial transformation strategies to the surrogate model, and performing multi-objective optimization processing on the plurality of initial transformation strategies on the basis of the parallel genetic algorithm plugin and an output of the surrogate model to obtain an optimal transformation strategy of the target building comprises:
constructing constraint conditions on the basis of an ideal transformation cost;
determining a predicted total building load of each of the initial transformation strategies according to the output of the surrogate model; and
acquiring the initial transformation strategy with the lowest predicted total building load as the optimal transformation strategy by using the parallel genetic algorithm plugin under the constraint conditions.

7. The generation method for the optimal transformation strategy for the building energy of claim 6, wherein the constructing constraint conditions on the basis of an ideal transformation cost comprises:
constructing the constraint conditions by adopting the following formula:
$$Cost = {\sum }_{i = 1}^{n} {ω}_{i} {ε}_{i} ;$$
wherein Cost represents the ideal transformation cost, ωᵢ represents a cost weight of an i^{th} transformation parameter under the adopted transformation strategy, εᵢ represents a linear cost index corresponding to a value of the i^{th} transformation parameter if a transformation cost of each transformation parameter within the corresponding sampling range linearly changes under the adopted transformation strategy, and n is a positive integer;
wherein,
$${ε}_{i} = \{ \begin{matrix}\frac{{x}_{i} - {a}_{i}}{{b}_{i} - {a}_{i}} , & {ρ}_{{Value}_{i} - Cost} > & 0 \\ \frac{{x}_{i} - {a}_{i}}{{b}_{i} - {a}_{i}} , & {ρ}_{{Value}_{i} - Cost} < & 0\end{matrix} ;$$
wherein xᵢ represents the value of the i^{th} transformation parameter; aᵢ represents an upper limit of a sampling range of the i^{th} transformation parameter; bᵢ represents a lower limit of the sampling range of the i^{th} transformation parameter; and ρ_{Value}_{ₜ}_{-Cost} represents a correlation between the value of the i^{th} transformation parameter and the transformation cost, wherein when ρ_{Value}_{ᵢ}_{-Cost}>0, it indicates that the i^{th} transformation parameter is positively correlated with the transformation cost, and the greater the value of the i^{th} transformation parameter is, the higher the corresponding transformation cost is, and when ρ_{Value}_{ᵢ}_{-Cost}<0, it indicates that the i^{th} transformation parameter is negatively correlated with the transformation cost, and the smaller the value of the i^{th} transformation parameter is, the higher the corresponding transformation cost is.

8. A computer device, wherein the computer device comprises:
a memory configured to store at least one instruction; and
a processor configured to execute the instruction stored in the memory so as to implement the generation method for the optimal transformation strategy for the building energy of claim 1.

9. A computer device, wherein the computer device comprises:
a memory configured to store at least one instruction; and
a processor configured to execute the instruction stored in the memory so as to implement the generation method for the optimal transformation strategy for the building energy of claim 2.

10. A computer device, wherein the computer device comprises:
a memory configured to store at least one instruction; and
a processor configured to execute the instruction stored in the memory so as to implement the generation method for the optimal transformation strategy for the building energy of claim 3.

11. A computer device, wherein the computer device comprises:
a memory configured to store at least one instruction; and
a processor configured to execute the instruction stored in the memory so as to implement the generation method for the optimal transformation strategy for the building energy of claim 4.

12. A computer device, wherein the computer device comprises:
a memory configured to store at least one instruction; and
a processor configured to execute the instruction stored in the memory so as to implement the generation method for the optimal transformation strategy for the building energy of claim 5.

13. A computer device, wherein the computer device comprises:
a memory configured to store at least one instruction; and
a processor configured to execute the instruction stored in the memory so as to implement the generation method for the optimal transformation strategy for the building energy of claim 6.

14. A computer device, wherein the computer device comprises:
a memory configured to store at least one instruction; and
a processor configured to execute the instruction stored in the memory so as to implement the generation method for the optimal transformation strategy for the building energy of claim 7.

15. A non-transitory computer-readable storage medium, wherein the computer-readable storage medium has at least one instruction stored therein, and the at least one instruction is executed by the processor in the computer device so as to implement the generation method for the optimal transformation strategy for the building energy of claim 1.

16. A non-transitory computer-readable storage medium, wherein the computer-readable storage medium has at least one instruction stored therein, and the at least one instruction is executed by the processor in the computer device so as to implement the generation method for the optimal transformation strategy for the building energy of claim 2.

17. A non-transitory computer-readable storage medium, wherein the computer-readable storage medium has at least one instruction stored therein, and the at least one instruction is executed by the processor in the computer device so as to implement the generation method for the optimal transformation strategy for the building energy of claim 3.

18. A non-transitory computer-readable storage medium, wherein the computer-readable storage medium has at least one instruction stored therein, and the at least one instruction is executed by the processor in the computer device so as to implement the generation method for the optimal transformation strategy for the building energy of claim 4.

19. A non-transitory computer-readable storage medium, wherein the computer-readable storage medium has at least one instruction stored therein, and the at least one instruction is executed by the processor in the computer device so as to implement the generation method for the optimal transformation strategy for the building energy of claim 5.

20. A non-transitory computer-readable storage medium, wherein the computer-readable storage medium has at least one instruction stored therein, and the at least one instruction is executed by the processor in the computer device so as to implement the generation method for the optimal transformation strategy for the building energy of claim 6.
